(19) United States
(12) Patent Application Publication
(10) Pub. No.: US 2006/0022838 A1
(43) Pub. Date: Feb. 2, 2006

(54) Speed limit indicia for traffic signals

(76) Inventor: Richard Alan Fisher, Huntington Beach, CA (US)

Correspondence Address: Roy A. Ekstrand;Ste. 150, 3158 Redhill Ave., Costa Mesa, CA, 92626, US

(21) Appl. No.: 10/899,893

(22) Filed: Jul. 27, 2004

(51) Int. Cl. G08B 5/00

(52) U.S. Cl. 340/815.4

(57) ABSTRACT

A traffic signal device includes a plurality of illuminatable light assemblies such as red amber and green used to control traffic flow. A transparent element configured to fit upon the outer surface of the lens of a light assembly supports one or more opaque numerals corresponding to vehicle speed limits. The transparent member baring the speed limit numerals is placed upon the outer surface of the traffic signal lens to impose the speed limit numerals upon the light emitted by the light assembly when illuminated.

### FIELD OF THE INVENTION

This invention relates generally to traffic control and signal apparatus of the type provided for communicating traffic control and regulatory information to vehicle operators.

### BACKGROUND OF THE INVENTION

Within most industrialized nations, substantial effort is expended in regulating and controlling vehicular traffic. One particularly important species of traffic control device is that which is used to control the passage of vehicles through intersecting portions of streets or roads.

In the United States of America for example, the most common traffic control device used at intersections of streets or roads is typically referred to as “traffic light”, “stop light”, or “traffic signal”. Such devices generally utilize one or more illuminatable signals or lights. Perhaps the most common device provides a red light (indicating an instruction to stop), a green light (indicating an instruction to proceed) and an amber light (indicating a transition from green to red).

A number of devices may be used for the light or signally portion of such control devices, one of the most well known and pervasive light or signal structures is provided by a simple reflector and color light filter or lens assembly having one or more incandescent lamps within the assembly interior. A newly emerging type of light or signal structure utilizes a lens assembly illuminated by a plurality of light emitting diodes to transmit light through the lens. The lens may be tinted to provide signal light color. Alternatively, a plurality of appropriately colored light emitting diodes may be selected to yield the desired light color.

Another important traffic control need arises in the regulation of vehicle speed. To maintain safe vehicle travel over streets, roads and the like, the maximum permissible speed for vehicles is usually posted along the roadside. Generally, a plurality of “speed limit” signs are provided at convenient positions along streets or roads and are positioned to be readily observable from vehicles passing thereby. While this system of posting speed limits along roadsides functions well for the most part, several limitations in its effectiveness arise. For example, growing vegetation such as trees or bushes along the roadside often obscure the visibility of signs from passing vehicles. In addition, substantial intervals exists between speed limit signs on most roads. As a result, vehicle drivers often travel some distance upon a street or road in ignorance of the maximum speed limit thereon.

Despite the best efforts of traffic control practitioners, there arises a continuing and unresolved general need in the art for improvement in the apparatus utilized in communicating traffic control information to vehicle operators. There further arises a particular need in the art for improvements in the apparatus utilized in such communication which supplements and cooperates in conjunction with conventional apparatus of the type presently used to enhance overall safety and control of vehicle operation.

### SUMMARY OF THE INVENTION

Accordingly, it is a general object of the present invention to provide an improved apparatus for communication of traffic control information to vehicle operators. It is a more particular object of the present invention to provide an improved supplemental communication apparatus for use in such control. It is a still more particular object of the present invention to provide an improved supplemental apparatus for use in combination with conventional traffic signals for communicating information to vehicle operators.

In accordance with the present invention, there is provided a speed limit indicia for use in combination with a traffic signal having one or more illuminatable signal light; the speed limit indicia comprising: a transparent element having an inner surface, constructed to overlay at least a portion of at least one of the illuminated signal lights, and an outer surface; and speed limit numerals upon the outer surface formed of a substantially contrasting material, the transparent element placed upon the outer surface and the speed limit numerals being visible when the illuminatable signal is illuminated to communicate a speed limit to vehicle operators. In another sense, the present invention provides a speed limit indicia constructed to be placed upon an illuminatable signal light, the speed limit indicia comprising: a thin transparent element constructed to be supported upon the illuminatable signal light; and a plurality of speed limit numerals formed upon the transparent element, the speed limit indicia being placed upon the illuminatable signal light to impose the speed limit numerals upon illumination produced when the illuminatable signal light is illuminated. In a further sense, the present invention provides a method, for improving a traffic signal having at least one illuminatable signal light, comprising the steps of: providing a transparent element constructed to conform generally to the at least one illuminatable signal light; forming substantially opaque speed limit numerals upon the transparent element; and placing the transparent element upon the at least one illuminatable signal light such that the speed limit numerals are visible when the at least one illuminatable signal light is illuminated.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a traffic signal in combination with the present invention speed limit indicia;

FIG. 2 sets forth a partial section view of the traffic signal of FIG. 1 taken along section lines 2-2 therein;

FIG. 3 sets forth a partial perspective assembly view of the present invention speed limit indicia together with a portion of a traffic signal;

FIG. 4 sets forth a partial side assembly view of the present invention speed limit indicia and a traffic signal;

FIG. 5 sets forth a partial assembly view of an alternate embodiment of the present invention speed limit indicia being applied to a traffic signal;

FIG. 6 sets forth a further alternate embodiment of the present invention speed limit indicia being assembled to a traffic signal; and

FIG. 7 sets forth a partial assembly view of a still further alternate embodiment of the present invention speed limit indicia and a traffic control signal.

### DESCRIPTION OF THE PREFERRED EMBODIMENTS OF THE INVENTION

FIG. 1 sets forth a front view of a typical traffic signal generally referenced by numeral 10 supporting a speed limit indicia 25 constructed in accordance with the present invention and applied to traffic signal 10 in accordance with the present invention method of improving traffic signals.

More specifically, traffic signal 10 is apart from indicia 25, fabricated in accordance with conventional fabrication techniques and includes a housing 11 which is supported by a vertical post 12. Housing 11 further supports a plurality of illuminatable signal light assemblies 13, 14 and 15 in a standard vertical arrangement. While the utilization of light assemblies 13, 14 and 15 may be varied in accordance with preference, in accordance with the generally standard arrangement utilized within the United States of America, light assembly 13 includes a lens 20 having a red color tint which is operable to emit red light colored illumination when light assembly 13 is illuminated. Similarly, light assembly 14 includes a light transmissive lens 21 tinted to provided to provide an amber colored light when light assembly 14 is illuminated. Finally, light assembly 15 includes a lens 22 having a red tint and operative to emit a red light when light assembly 15 is illuminated.

In accordance with the present invention, a speed limit indicia 25 is supported upon lens 22 and bares a pair of speed limit numerals 26 and 27. While it is recognized that indicia 25 may be equally well positioned upon light assemblies 13 or 14, it has been found preferred to place light indicia 25 upon the green light or “go” signal provided by light assembly 15. This is preferable due to the likelihood that drivers observing traffic signal 10 at a stop will pay attention to the illumination of green light assembly 15. Further, it is preferably because vehicle drivers approaching an intersection controlled by traffic signal 10 are equally likely to look for and observe the illumination of green light assembly 15 before proceeding through the controlled intersection. Accordingly, with green light assembly 15 illuminated, numeral 26 and 27 which in the example of FIG. 1 provide an indication of a thirty five mile per hour maximum speed limit are very visible to vehicle operators. It will be apparent to those skilled in the art that the virtually automatic attention which vehicle operators give to the controlling traffic signal within an intersection ensures that the supplemental or reinforcing indication of speed limit applicable to the continuing portion of the street or road leading from the controlled intersection will be clearly and unambiguously observed by vehicle operators. It will be apparent to those skilled in the art that numeral 26 and 27 may be formed of virtually any material or color which provides sufficient contrast with the clear portion of indicia 25 described below and the green light emitted from light assembly 15. However, it has been found preferable to utilize an opaque material preferably a dark color such as black to define numerals 26 and 27.

In accordance with the preferred fabrication of the present invention, indicia 25 is fabricated of a transparent plastic material which readily and easily is applied to and adheres to the outer lens surface of lens 22. The attachment of indicia 25 may, if desired, utilize a temporary adhesive or tape. However, it has been found preferable to utilize material for indicia 25 which readily adheres to the surface of lens 22 without adhesive. Such materials are common and well known in the art and are utilized for example to apply temporary stickers or labels to glass surfaces without adhesive. The avoidance of adhesive renders indicia 25 capable of easy removal and replacement in order to update speed limit numeral data. Also it is recognized that over time indicia 25 may require removal for cleaning and other maintenance and activity.

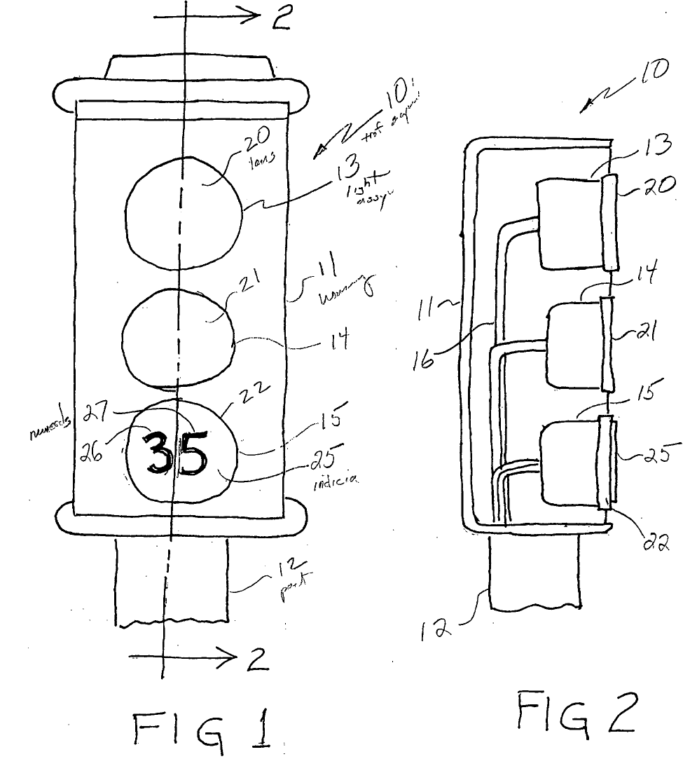

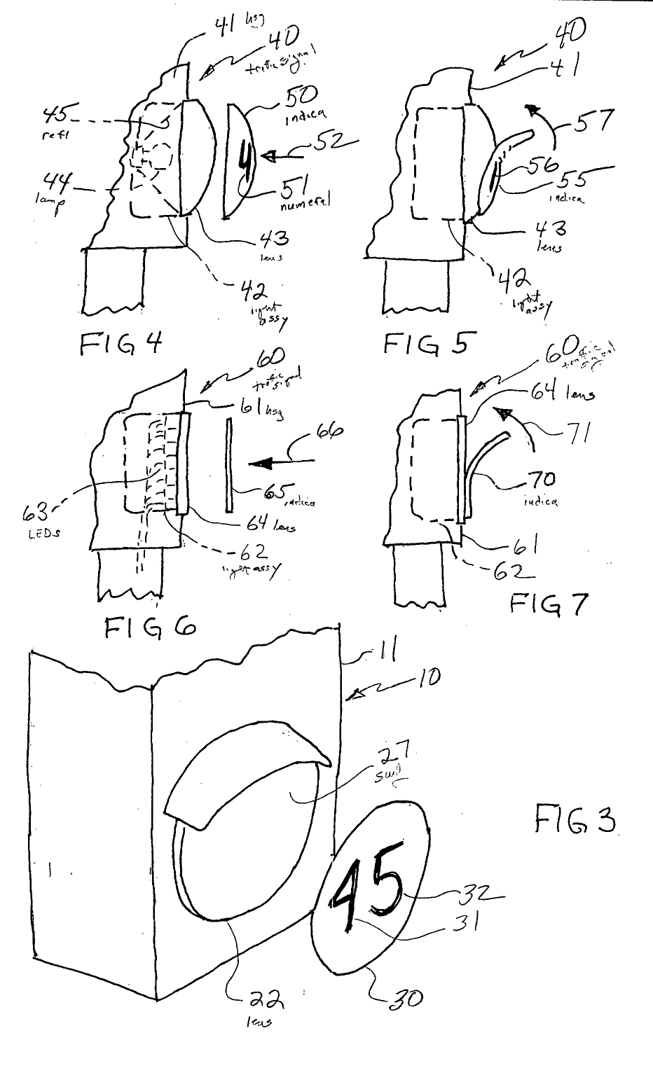

FIG. 2 sets forth a partial section view of traffic signal 10 taken along section lines 2-2 in FIG. 1. As described above, traffic signal 10 is fabricated in accordance with conventional fabrication techniques but for the installation of indicia 25. Accordingly, traffic signal 10 includes a housing 11 supported by a post 12 and further supporting a red light assembly 13, an amber light assembly 14, and a green light assembly 15. In further accordance with conventional fabrication techniques, a plurality of connecting wires 16 are operative to couple the illumination devices within light assemblies 13, 14 and 15 (seen in FIGS. 4 and 6) to a source of controlling electrical power (not shown). Light assemblies 13, 14 and 15 further support a red light lens 20, an amber light lens 21 and a green light lens 22. In accordance with the present invention, speed limit indicia 25 having speed limit numerals 26 and 27 is supported upon the outer surface of lens 22.

FIG. 3 sets forth a partial perspective assembly view of traffic signal 10 having an indicia 30 being assembled thereto. In accordance with the above-described structure, traffic signal 10 includes a housing 11 which supports a green light lens 22. Lens 22 in the embodiment shown in FIGS. 1, 2 and 3 forms a substantially planar lens having a substantially planar outer surface 27. Accordingly, an indicia 30 fabricated in accordance with the present invention, defines a generally flat shape in correspondence with surface 27. Indicia 30 may be fabricated utilizing a relatively stiff plastic material preferably transparent or alternatively may be formed of a relatively thin flexible transparent membrane as desired. Indicia 30 is shown supporting speed limit numerals 31 and 32 to indicate a forty five mile per hour speed limit. As described above, the preferred fabrication of the present invention speed limit indicia utilizes a plastic material of the type which readily adheres to another plastic or glass surface without the need for adhesives. Thus, in the assembly shown in FIG. 3, indicia 30 baring numeral 31 and 32 is aligned with surface 27 and pressed against surface 27 to provide adhesion.

Once indicia 30 has been pressed against surface 27 and any air bubbles trapped between indicia 30 and surface 27 have been worked or massaged out, indicia 30 remains against surface 27 of lens 22. Correspondingly, each time lens 22 is illuminated by the green light assembly (assembly 15 seen in FIGS. 1 and 2), the green light shinning outwardly through lens 22 passes through transparent indicia 30 and thereby has the shapes of numerals 31 and 32 imposed on the transmitted light. States simply, once the green light assembly supporting indicia 30 is illuminated, numerals 31 and 32 become clearly visible to those drivers observing the traffic signal.

It is important to note that the preferred use of the present invention speed limit indicia for traffic signals is primarily intended to provide additional or supplemental communication of speed limits for traffic control. Thus, in the most likely utilization of the present invention speed limit indicia, the conventional posted speed limit signs presently used would continue in use. However, it will be apparent that the addition of the present invention speed limit indicia will further enhance the communication of speed limits to vehicle operators due to the inherent likelihood that such operators will observe the traffic light signals while driving. In addition, with the communication of speed limit numerals utilizing the present invention indicia, drivers passing through a controlled intersection will immediately know the speed limit for the upcoming road portion rather than being ignorant of the speed limit until encountering the next posted speed limit sign.

By way of overview, FIGS. 4 through 7 set forth alternate embodiments of the present invention which are directed primarily toward accommodating different shapes of lens for traffic signal light assemblies. By way of further overview, FIGS. 4 and 6 illustrate the use of relatively stiff transparent elements which are preformed to conform to the outer surface of the host light assembly while FIGS. 5 and 7 illustrate the alternate fabrication of the present invention in which the transparent element of the present speed limit indicia is formed of a relatively thin flexible material.

More specifically, FIG. 4 sets forth a partial side view of a conventional traffic signal 40 having a light assembly 42 supported thereon. Light assembly 42 is fabricated to include a reflector 45 and an incandescent lamp 44. A tinted lens 43 which may for example be colored green is supported on the outer surface of housing 41. In the fabrication utilized in traffic signal 40, the outer surface of lens 43 is generally spherical in shape. Correspondingly, a speed limit indicia 50 fabricated in accordance with the present invention and formed of a generally spherically shaped transparent material such as plastic or the like bares one of more speed limit numerals such as numeral 51.

The assembly of indicia 50 to lens 43 is carried forward by simply forcing indicia 50 against the outer surface of lens 43 in the direction indicated by arrow 52. As mentioned above, an adhesive or tape attachment material may be utilized to secure indicia 50. However, as is also described above, the preferred fabrication of the present invention utilizes the adhesion of the material of indicia 50 to the surface of lens 43 to provide sufficient retention thereof. In this manner, indicia 50 may be readily removed from lens 43 and replaced or renewed.

FIG. 5 sets forth a partial side view of an alternate embodiment of the present invention indicia generally referenced by numeral 55. As described in FIG. 4, traffic signal 40 includes a housing 41 supporting a light assembly 42 which includes a spherically curved lens 43. In accordance with the alternate embodiment of the present invention, indicia 55 is fabricated of a flexible thin membrane which is readily conformed to the curved surface of lens 43. While the thin flexible material of indicia 55 may be formed in a flat shape and formed upon the surface of lens 43 due to its flexibility, in the preferred fabrication of the present invention, indicia 55 is preformed with a shape generally corresponding to the curved shape of lens 43. In such case, indicia 55 baring speed limit numerals such as numeral 56 is positioned against the outer surface of lens 43 and then formed upon the outer surface of lens 43 as indicated by arrow 57.

FIG. 6 sets forth a side view of a portion of a conventional traffic signal 60 together with a still further alternate embodiment of the present invention speed limit indicia. Traffic signal 60 includes a housing 61 having a light assembly 62 supported therein. Light assembly 62 includes a generally planar lens 64 having a generally flat outer surface. Light assembly 62 further includes a plurality of light emitting diodes 63 supported behind lens 64 in a dense array which provide relatively uniform illumination of lens 64. In accordance with the embodiment of the present invention set forth in FIG. 6, a generally planar speed limit indicia 65 is fabricated of a relatively stiff transparent material such as plastic or the like. Indicia 65 is assembled to lens 64 by pressing it against the outer surface of lens 64 in the direction indicated by arrow 66. Once again, it will be noted that an adhesive or attachment material such as tape or the like may be utilized in securing indicia 65 to the outer surface of lens 64. However, in the preferred fabrication of the present invention, the material of indicia 65 is selected to provide the above mentioned type of adhesion or attachment to lens 64.

FIG. 7 sets forth a partial side view of a traffic signal 60 having a still further alternate embodiment of the present invention speed limit indicia generally referenced by numeral 70 being assembled thereto. As described above, traffic signal 60 is fabricated in accordance with conventional fabrication techniques and includes a light assembly 62 having a generally planar 64. An indicia 70 fabricated in accordance with an alternate embodiment of the present invention is formed of a transparent relatively thin and flexible membrane such as plastic or the like. Indicia 70 which supports one or more speed limit numerals in the manner indicated for example in FIG. 3 is assembled to lens 64 by simply pressing indicia 70 in a manner indicated by arrow 71 to secure indicia 70. Indicia 70 is easily removed from lens 64 in a reverse operation by simply grasping any edge portion of indicia 70 and withdrawing it away from lens 64.

What has been shown is a speed limit indicia for traffic signals which is easy to manufacture and low in cost while providing effective communication of import speed information to vehicle operators. The speed limit indicia provided by the present invention is usable in virtually any type of traffic signal device and is particularly adaptable to the conventional traffic lights utilized within the United States of America. Embodiments are shown which accommodate both curved lens light assemblies as well as generally flat light assemblies.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A speed limit indicia for use in combination with a traffic signal having one or more illuminatable signal light; said speed limit indicia comprising:
a transparent element having an inner surface, constructed to overlay at least a portion of at least one of said illuminated signal lights, and an outer surface; and
speed limit numerals upon said outer surface formed of a substantially contrasting material,
said transparent element placed upon said outer surface and said speed limit numerals being visible when said illuminatable signal is illuminated to communicate a speed limit to vehicle operators.

2. The speed limit indicia set forth in claim 1 wherein said transparent element is formed of a transparent plastic material.

3. The speed limit indicia set forth in claim 2 wherein said speed limit numerals are formed of a substantially opaque material.

4. The speed limit indicia set forth in claim 3 wherein said speed limit numerals are substantially black.

5. The speed limit indicia set forth in claim 3 wherein said transparent element is formed of a thin flexible membrane.

6. The speed limit indicia set forth in claim 5 wherein said illuminatable signal light includes a lens having a generally curved outer surface and wherein said thin flexible membrane defines a correspondingly curved shape.

7. The speed limit indicia set forth in claim 5 wherein said illuminatable signal light includes a lens having a generally flat outer surface and wherein said thin flexible membrane defines a generally flat shape.

8. The speed limit indicia set forth in claim 3 wherein said illuminatable signal includes a lens having a generally curved outer surface and wherein said transparent element defines a correspondingly curved shape.

9. The speed limit indicia set forth in claim 8 wherein said illuminatable signal includes a lens having a generally flat outer surface and wherein said transparent element defines a generally flat shape.

10. A speed limit indicia constructed to be placed upon an illuminatable signal light, said speed limit indicia comprising:
a thin transparent element constructed to be supported upon said illuminatable signal light; and
a plurality of speed limit numerals formed upon said transparent element,
said speed limit indicia being placed upon said illuminatable signal light to impose said speed limit numerals upon illumination produced when said illuminatable signal light is illuminated.

11. A method, for improving a traffic signal having at least one illuminatable signal light, comprising the steps of:
providing a transparent element constructed to conform generally to said at least one illuminatable signal light;
forming substantially opaque speed limit numerals upon said transparent element; and
placing said transparent element upon said at least one illuminatable signal light such that said speed limit numerals are visible when said at least one illuminatable signal light is illuminated.
